(19) United States
(12) Patent Application Publication
(10) Pub. No.: US 2008/0083999 A1
(43) Pub. Date: Apr. 10, 2008

(54) PROCESS FOR MAKING AN OPTICAL FILM

(75) Inventors: William W. Merrill, White Bear Lake, MN (US); Andrew J. Ouderkirk, Woodbury, MN (US); Matthew B. Johnson, St. Paul, MN (US); Mark B. O'Neill, Stillwater, MN (US); Martin E. Denker, Vadnais Heights, MN (US); Timothy J. Hebrink, Scandia, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/539,320

(22) Filed: Oct. 6, 2006

(51) Int. Cl. B29D 11/00

(52) U.S. Cl. 264/2.7

(57) ABSTRACT

Exemplary methods include includes providing a film comprising at least one polymeric material; widening the film under a first set of processing conditions in a first draw step along the crossweb direction such that in-plane birefringence, if any, created in the film is low; and drawing the film in a second draw step along a downweb direction, while allowing the film to relax along the crossweb direction, under a second set of processing conditions, wherein the second set of processing conditions creates in-plane birefringence in at least one polymeric material.

### TECHNICAL FIELD

This disclosure relates generally to optical films and methods for making optical films.

### BACKGROUND

In commercial processes, optical films made from polymeric materials or blends of materials are typically extruded from a die or cast from solvent. The extruded or cast film is then stretched to create and/or enhance birefringence in at least some of the materials. The materials and the stretching protocol may be selected to produce an optical film such as a reflective optical film, for example, a reflective polarizer or a mirror. Some such optical films may be referred to as brightness-enhancing optical films, because brightness of a liquid crystal optical display may be increased by including such an optical film therein.

### SUMMARY

In one exemplary implementation, the present disclosure is directed to methods of making optical films. One exemplary method includes providing a film comprising at least one polymeric material: widening the film under a first set of processing conditions in a first draw step along a crossweb (TD) direction such that birefringence, if any, created in the film is low; and drawing the film in a second draw step along a downweb (MD) direction, while allowing the film to relax along the crossweb (TD) direction, under a second set of processing conditions, wherein the second set of processing conditions creates in-plane birefringence in the polymeric material and an effective orientation axis along the MD.

Another exemplary method of the present disclosure includes the steps of providing a film comprising at least a first polymeric material and a second polymeric material, drawing the film in a first draw step along a crossweb (TD) direction to widen the film under a first set of processing conditions such that low in-plane birefringence is created in the first and second polymeric materials, and drawing the film in a second draw step along a downweb (MD) direction, while allowing the film to relax along the crossweb (TD) direction, under a second set of processing conditions to create in-plane birefringence in at least one of the first and second polymeric materials and an effective orientation axis along the MD.

Yet another exemplary method of the present disclosure includes the steps of providing a first film comprising at least a first polymeric material and a second polymeric material, drawing the first film in a first draw step along a crossweb (TD) direction to widen the first film under a first set of processing conditions such that low in-plane birefringence is created in the first and second polymeric materials, drawing the first film in a second draw step along a downweb (MD) direction, while allowing the film to relax along the crossweb (TD) direction, under a second set of processing conditions to create in-plane birefringence in at least one of the first and second polymeric materials and an effective orientation along the MD; and attaching a second film to the first optical film.

The above summary is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1 and 2 illustrate optical films;

FIG. 3 illustrates a blended optical film;

FIG. 4 is a schematic representation of an apparatus and process for making an optical film according to the present disclosure;

FIG. 5 is a schematic illustration of the stretching process according to one embodiment of the present disclosure;

FIG. 6 is a schematic illustration of a batch stretching process step;

FIG. 7A is a schematic diagram of an embodiment of a film line using a length orienter;

FIG. 7B is a schematic diagram of one embodiment of a length orienter threading system;

FIG. 7C is a schematic diagram of another embodiment of a length orienter threading system;

FIG. 8 illustrates a laminate construction in which a first optical film is attached to a second optical film;

FIGS. 9A-9B are cross-sectional views of exemplary constructions made according to the present disclosure;

FIGS. 10A-10C are cross-sectional views of exemplary constructions made according to the present disclosure; and

FIG. 11 is a cross-sectional view of an exemplary construction made according to the present disclosure.

### DETAILED DESCRIPTION

The present disclosure is directed to making optical films, such as optical films capable of enhancing brightness of a display. Optical films differ from other films, for example, in that they require optical uniformity and sufficient optical quality designed for a particular end use application, such as optical displays. For the purposes of this application, sufficient quality for use in optical displays means that the optical films in roll form, following all processing steps and prior to lamination to other films, are free of significant visible defects, e.g., have substantially no color streaks or surface ridges when viewed by an unaided human eye. In addition, an optical quality film should have caliper variations over the useful film area that are sufficiently small for a particular application, e.g., no more than ±10%, ±5%, no more than ±3% and in some cases no more than ±1% of the average thickness of the film. Spatial gradient of caliper variations also should be sufficiently small to avoid undesirable appearance or properties of optical films according to the present disclosure. For example, the same amount of caliper variation will be less undesirable if it occurs over a larger area.

Methods for making wide oriented optical films, such as reflective polarizing films having a block or polarizing axis along their length (along the MD), and rolls of wide films having a block or polarizing axis along their length (along the MD) that may be produced by such methods, are described in commonly owned U.S. application Ser. Nos. 11/394,479 and 11/394,478, both filed on Mar. 31, 2006, the disclosures of which are hereby incorporated by reference herein. The reflective polarizing films may include, without limitation, multilayer reflective polarizing films and diffusely reflective polarizing optical films. In some exemplary embodiments, the reflective polarizing films may be advantageously laminated to other optical films, such as absorbing polarizers, retarders, diffusers, protective films, surface structured films, etc., in roll-to-roll processes.

For the purposes of the present application, the term “wide” or “wide format” refers to films having a width of greater than about 0.3 m. Those of ordinary skill in the art will readily appreciate that the term “width” will be used in reference to the useful film width, since some portions of the edge of the film may be rendered unusable or defective, e.g., by the gripping members of a tenter. The wide optical films of the present disclosure have a width that may vary depending on the intended application, but widths typically range from more than 0.3 m to 10 m. In some applications, films wider than 10 m may be produced, but such films can be difficult to transport. Exemplary suitable films typically have widths from about 0.5 m to about 2 m and up to about 7 m, and currently available display film products utilize films having widths of, for example, 0.65 m, 1.3 m, 1.6 m, 1.8 m or 2.0 m. The term “roll” refers to a continuous film having a length of at least 10 m. In some exemplary embodiments of the present disclosure, the length of the film may be 20 m or more, 50 m or more, 100 m or more, 200 m or more or any other suitable length.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The principal axes refer to the directions where the indices of refraction are at the maximum and minimum values. The term “in-plane birefringence” is understood to be the difference between the principal in-plane indices (nₓ and n_{y}) of refraction. The term “out-of-plane birefringence” is understood to be the difference between one of the principal in-plane indices (nₓ or n_{y}) of refraction and the principal out-of-plane index of refraction n_{z}. The principal in-plane directions typically align in approximately the crossweb/transverse direction (TD) and the downweb/machine direction (MD), especially in the center of the film in a cross-web symmetric process. The principal out-of-plane direction may approximate the normal direction (ND). All birefringence and index of refraction values are reported for 632.8 nm light unless otherwise indicated.

A birefringent, oriented layer typically exhibits a difference between the transmission and/or reflection of incident light rays having a plane of polarization parallel to the oriented direction (i.e., stretch direction) and light rays having a plane of polarization parallel to a transverse direction (i.e., a direction orthogonal to the stretch direction). For example, when an orientable polyester film is stretched along the x axis, the typical result is that nₓ≠n_{y}, where nₓ and n_{y} are the indices of refraction for light polarized in a plane parallel to the “x” and “y” axes, respectively. The degree of alteration in the index of refraction along the stretch direction will depend on factors such as the amount of stretching, the stretch rate, the temperature of the film during stretching, the thickness of the film, the variation in the film thickness, and the composition of the film.

It will be appreciated that the refractive index in a material is a function of wavelength (i.e., materials typically exhibit dispersion). Therefore, the optical requirements on refractive index are also a function of wavelength. The index ratio of two optically interfaced materials can be used to calculate the reflective power of the two materials. The absolute value of the refractive index difference between the two materials for light polarized along a particular direction divided by the average refractive index of those materials for light polarized along the same direction is descriptive of the film's optical performance. This will be called the normalized refractive index difference.

In a reflective polarizer, it is generally desirable that the normalized difference, if any, in mismatched in-plane refractive refractive indices, e.g., in-plane (MD) direction, be at least about 0.06, more preferably at least about 0.09, and even more preferably at least about 0.11 or more. More generally, it is desirable to have this difference as large as possible without significantly degrading other aspects of the optical film. It is also generally desirable that the normalized difference, if any, in matched in-plane refractive indices, e.g., in the in-plane (TD) direction, be less than about 0.06, more preferably less than about 0.03, and most preferably less than about 0.01. Similarly, it can be desirable that any normalized difference in refractive indices in the thickness direction of a polarizing film, e.g., in the out-of-plane (ND) direction, be less than about 0.11, less than about 0.09, less than about 0.06, more preferably less than about 0.03, and most preferably less than about 0.01.

In certain instances it may desirable to have a controlled mismatch in the thickness direction of two adjacent materials in a multilayer stack. The influence of the z-axis refractive indices of two materials in a multilayer film on the optical performance of such a film are described more fully in U.S. Pat. No. 5,882,774, entitled Optical Film; U.S. Pat. No. 6,531,230, entitled “Color Shifting Film;” and U.S. Pat. No. 6,157,490, entitled “Optical Film with Sharpened Bandedge,” the contents of which are incorporated herein by reference. In some exemplary optical films, it is generally desirable that the normalized difference, if any, between the refractive index for light polarized along the non-stretch direction nₓ and the refractive index for light polarized along the thickness direction n_{z} be as small as possible, for example, less than about 0.06, more preferably less than about 0.03, and most preferably less than about 0.01.

Exemplary embodiments of the present disclosure may be characterized by “an effective orientation axis,” which is the in-plane direction in which the refractive index has changed the most as a result of strain-induced orientation. For example, the effective orientation axis typically coincides with the block axis of a polarizing film, reflective or absorbing. In general, there are two principal axes for the in-plane refractive indices, which correspond to maximum and minimum refractive index values. For a positively birefringent material, in which the refractive index tends to increase for light polarized along the main axis or direction of stretching, the effective orientation axis coincides with the axis of maximum in-plane refractive index. For a negatively birefringent material, in which the refractive index tends to decrease for light polarized along the main axis or direction of stretching, the effective orientation axis coincides with the axis of minimum in-plane refractive index.

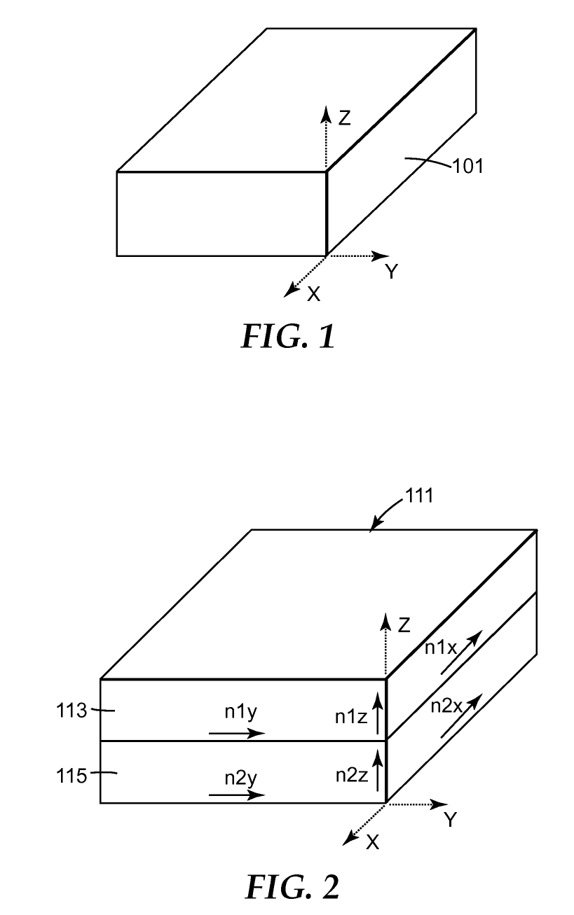

FIG. 1 illustrates a portion of an optical film construction 101 that may be used in the processes described below. The depicted optical film 101 may be described with reference to three mutually orthogonal axes x, y and z. In the illustrated embodiment, two orthogonal axes x and y are in the plane of the film 101 and a third axis (z-axis) extends in the direction of the film thickness. In some exemplary embodiments, the optical film 101 includes at least two different materials, a first material and a second material, which are optically interfaced (e.g., two materials which combine to cause an optical effect such as reflection, scattering, transmission, etc.). In typical embodiments of the present disclosure, one or both materials are polymeric.

The first and second materials may be selected to produce a desired mismatch of refractive indices in a direction along at least one axis of the film 101, for example, along the x direction. Preferably, the mismatch in refractive indices along the y direction is at least 0.05, at least 0.07, at least 0.1 and more preferably at least 0.2. The materials may also be selected produce a desired match of refractive indices in a direction along at least one other axis of the film 101, perpendicular to a direction along which the refractive indices are mismatched, for example, along y direction. Preferably, the difference between refractive indices along the x direction is less than 0.05, 0.04 or less, 0.03 or less, and more preferably 0.02 or less. In some exemplary embodiments, the materials may also be selected produce a desired match of refractive indices in a direction along two axes of the film 101 perpendicular to a direction along which the refractive indices are mismatched, for example, along both y and x directions. In such exemplary embodiments, the differences between refractive indices of the first and second materials along the x and y directions are both less than 0.05, 0.04 or less, 0.03 or less, and more preferably 0.02 or less.

At least one of the first and second materials may be subject to developing negative or positive birefringence under certain conditions. The materials used in the optical film are preferably selected to have sufficiently similar rheology to meet the requirements of a coextrusion process, although cast films can also be used. In other exemplary embodiments, the optical film 101 may be composed of only one material or a miscible blend of two or more materials. Such exemplary embodiments may be used as retarders or compensators in optical displays.

In some exemplary embodiments, an optical film of the present disclosure includes a birefringent material, and, sometimes, only one birefringent material. In other exemplary embodiments, an optical film of the present disclosure includes at least one birefringent material and at least one isotropic material. In yet other exemplary embodiments, the optical film includes a first birefringent material and a second birefringent material. In some such exemplary embodiments, the in-plane refractive indices of both materials change similarly in response to the same process conditions. In one embodiment, when the film is drawn, the refractive indices of the first and second materials should both increase for light polarized along the direction of the draw (e.g., the MD) while decreasing for light polarized along a direction orthogonal to the stretch direction (e.g., the TD). In another embodiment, when the film is drawn, the refractive indices of the first and second materials should both decrease for light polarized along the direction of the draw (e.g., the MD) while increasing for light polarized along a direction orthogonal to the stretch direction (e.g., the TD). In general, where one, two or more birefringent materials are used in an oriented optical film according to the present disclosure, the effective orientation axis of each birefringent material is aligned along the MD.

When the orientation resulting from a draw step or combination of draw steps causes a match of the refractive indices of the two materials in one in-plane direction and a substantial mismatch of the refractive indices in the other in-plane direction, the film is especially suited for fabricating a reflective polarizer. The matched direction forms a transmission (pass) direction for the polarizer and the mismatched direction forms a reflection (block) direction. Generally, the larger the mismatch in refractive indices in the reflection direction and the closer the match in the transmission direction, the better the performance of the polarizer.

On the other hand, where a birefringent material or materials exhibit a difference between the refractive indices along the non-stretch directions, e.g., along y and z directions, some optical films used in polarizer applications suffer from off-axis color. Thus, the birefringent materials comprised in exemplary embodiments of the present disclosure should have a mismatch between refractive indices along the non-stretch directions as small as possible. The refractive indices in the non-stretched directions (i.e., the y-direction and the z-direction) are desirably within about 5% of one another for a given birefringent layer or region, and, in embodiments comprising more than one material, within about 5% of the corresponding non-stretched directions of an adjacent layer or region of a different material.

FIG. 2 illustrates a multilayer optical film 111 that includes a first layer of a first material 113 disposed (e.g., by coextrusion) on a second layer of a second material 115. Either or both of the first and second materials may be birefringent. While only two layers are illustrated in FIG. 2 and generally described herein, the process is applicable to multilayer optical films having up to hundreds or thousands or more of layers made from any number of different materials, e.g., a plurality first layers of a first material 113 and a plurality of second layers of a second material 115. The multilayer optical film 111 or the optical film 101 may include additional layers. The additional layers may be optical, e.g., performing an additional optical function, or non-optical, e.g., selected for their mechanical or chemical properties, or both. As discussed in U.S. Pat. No. 6,179,948, incorporated herein by reference, these additional layers may be orientable under the process conditions described herein, and may contribute to the overall optical and/or mechanical properties of the film, but for the purposes of clarity and simplicity these layers will not be further discussed in this application.

The materials in the optical film 111 are selected to have visco-elasticity characteristics to at least partially decouple the draw behavior of the two materials 113 and 115 in the film 111. For example, in some exemplary embodiments, it is advantageous to decouple the responses of the two materials 113 and 115 to stretching or drawing. By decoupling the draw behavior, changes in the refractive indices of the materials may be separately controlled to obtain various combinations of orientation states, and, consequently, the degrees of birefringence, in the two different materials. In one such process, two different materials form optical layers of a multilayer optical film, such as a coextruded multilayer optical film. The indices of refraction of the layers can have an initial isotropy (i.e., the indices are the same along each axis) although some orientation during the casting process may be purposefully or incidentally introduced in the extruded films.

One approach to forming a reflective polarizer uses a first material that becomes birefringent as a result of processing according to the present disclosure and a second material having an index of refraction which remains substantially isotropic, i.e., does not develop appreciable amounts of birefringence, during the draw process. In some exemplary embodiments, the second material is selected to have a refractive index which matches the non-drawn in-plane refractive index of the first material subsequent to the draw.

Materials suitable for use in the optical films of FIGS. 1, 2 are discussed in, for example, U.S. Pat. No. 5,882,774, which is incorporated herein by reference. Suitable materials include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof; t-butyl isophthalic acid, trimellitic acid, sodium sulfonated isophthalic acid; 2,2′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbomanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis(2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyethylene terephthalate (PET), and copolymers thereof.

In some exemplary embodiments, a second polymer of the second optical layers should be chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,762 and 6,498,683 and U.S. patent applications Ser. Nos. 09/229724, 09/232332, 09/399531, and 09/444756, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to the isotropic refractive index of the first polymer. Examples of other polymers suitable for use in optical films and, particularly, in the second optical layers, other than the CoPEN polymers discussed above, include vinyl polymers and copolymers made from monomers such as vinyl naphthalenes, styrene, maleic anhydride, acrylates, and methacrylates. Examples of such polymers include polyacrylates, polymethacrylates, such as poly(methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers and copolymers such as polyesters and polycarbonates.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008.

Yet other suitable polymers, especially for use in the second optical layers, include polyolefin copolymers such as poly(ethylene-co-octene) (PE-PO) available from Dow-Dupont Elastomers under the trade designation Engage 8200, poly(propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, PET/co-PET and PET/sPS, where “co-PET” refers to a copolymer or blend based upon terephthalic acid (as described above), ECDEL is a thermoplastic polyester commercially available from Eastman Chemical Co., and THV is a fluoropolymer commercially available from 3M Company. PMMA refers to polymethyl methacrylate and PETG refers to a copolymer of PET employing a second glycol (usually cyclohexanedimethanol). sPS refers to syndiotactic polystyrene.

In another embodiment, the optical film can be or can include a blend optical film. In some exemplary embodiments, the blend optical film may be a diffuse reflective polarizer. In a typical blend film according to the present disclosure, a blend (or mixture) of at least two different materials is used. A mismatch in refractive indices of the two or more materials along a particular axis can be used to cause incident light which is polarized along that axis to be substantially scattered, resulting in a significant amount of diffuse reflection of that light. Incident light which is polarized in the direction of an axis in which the refractive indices of the two or more materials are matched will be substantially transmitted or at least transmitted with a much lesser degree of scattering. By controlling the relative refractive indices of the materials, among other properties of the optical film, a diffusely reflective polarizer may be constructed. Such blend films may assume a number of different forms. For example, the blend optical film may include one or more co-continuous phases, one or more disperse phases within one or more continuous phases or co-continuous phases. The general formation and optical properties of various blend films are further discussed in U.S. Pat. Nos. 5,825,543 and 6,111,696, the disclosures of which are incorporated by reference herein.

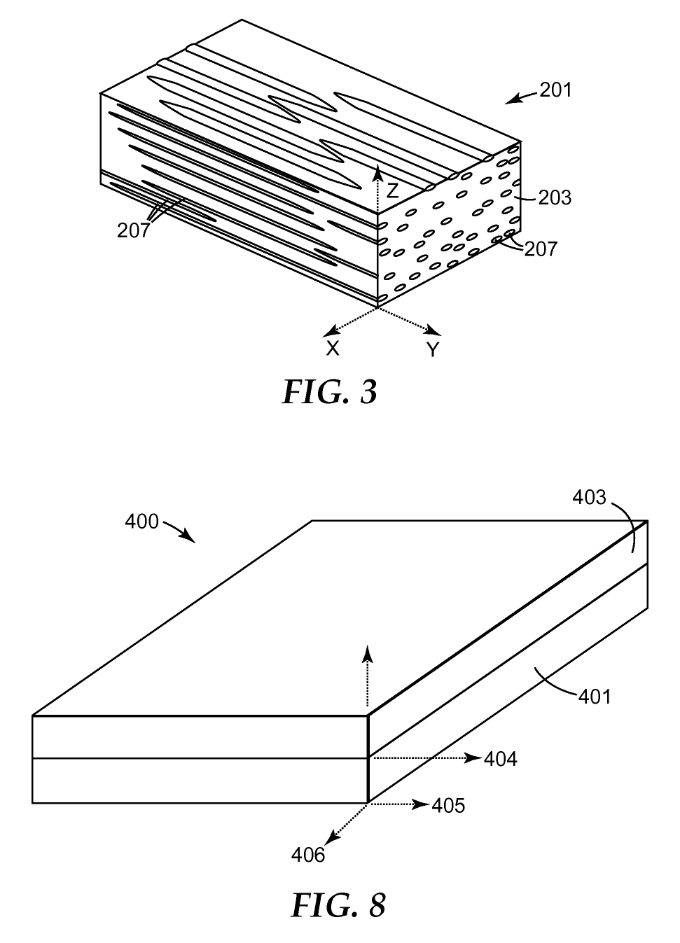

FIG. 3 illustrates an embodiment of the present disclosure formed of a blend of a first material and a second material that is substantially immiscible in the first material. In FIG. 3, an optical film 201 is formed of a continuous (matrix) phase 203 and a disperse (discontinuous) phase 207. The continuous phase may comprise the first material and the second phase may comprise the second material. The optical properties of the film may be used to form a diffusely reflective polarizing film. In such a film, the refractive indices of the continuous and disperse phase materials are substantially matched along one in-plane axis and are substantially mismatched along another in-plane axis. Generally, one or both of the materials are capable of developing in-plane birefringence as a result of stretching or drawing under the appropriate conditions. In the diffusely reflective polarizer, such as that shown in FIG. 3, it is desirable to match the refractive indices of the materials in the direction of one in-plane axis of the film as close as possible while having as large of a refractive indices mismatch as possible in the direction of the other in-plane axis.

If the optical film is a blend film including a disperse phase and a continuous phase as shown in FIG. 3 or a blend film including a first co-continuous phase and a second co-continuous phase, many different materials may be used as the continuous or disperse phases. Such materials include inorganic materials such as silica-based polymers, organic materials such as liquid crystals, and polymeric materials, including monomers, copolymers, grafted polymers, and mixtures or blends thereof. The materials selected for use as the continuous and disperse phases or as co-continuous phases in the blend optical film having the properties of a diffusely reflective polarizer may, in some exemplary embodiments, include at least one optical material that is orientable under the second set of processing conditions to introduce in-plane birefringence and at least one material that does not appreciably orient under the second set of processing conditions and does not develop an appreciable amount of birefringence.

Details regarding materials selection for blend films are set forth in U.S. Pat. Nos. 5,825,543 and 6,590,705, both incorporated by reference.

Suitable materials for the continuous phase (which also may used in the disperse phase in certain constructions or in a co-continuous phase) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters. PEN and PET, as well as copolymers of intermediate compositions, are especially preferred because of their strain induced birefringence, and because of their ability to remain permanently birefringent after stretching.

Suitable materials for the second polymer in some film constructions include materials that are isotropic or birefringent when oriented under the conditions used to generate the appropriate level of birefringence in the first polymeric material. Suitable examples include polycarbonates (PC) and copolycarbonates, polystyrene-polymethylmethacrylate copolymers (PS-PMMA), PS-PMMA-acrylate copolymers such as, for example, those available under the trade designation MS 600 (50% acrylate content) NAS 21 (20% acrylate content) from Nova Chemical, Moon Township Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC), and polychloroprene.

In one aspect, the present disclosure is directed to a method of making a roll of wide oriented optical film useful, for example, in an optical display, in which the effective orientation axis of the oriented optical film is generally aligned with the length of the roll. Rolls of this film, such as a reflective polarizing film, may be easily laminated to rolls of other optical films that have a block state axis along their length, such as absorbing polarizing films. One exemplary roll includes an oriented optical film comprising a birefringent material characterized by an effective orientation axis along the MD and a normalized difference between a refractive index for light polarized along the TD and a refractive index for light polarized along the ND is less than 0.06.

Exemplary methods of the present disclosure include providing an optical film that is made of at least one polymeric material, preferably at least a first and a second polymeric material, wherein at least one of the polymeric materials is capable of developing birefringence. The optical film is stretched or drawn in the crossweb (TD) direction in a first step, referred to generally herein as the first draw step, to widen the film under a first set of processing conditions such that only low in-plane birefringence, if any, is developed in the film.

The term widen as used herein refers to a process step in which the film dimensions are changed without introducing substantial molecular orientation, preferably no molecular orientation, into the polymeric molecules making up the film. When a film is widened in a first process step, the process conditions, for example, temperature, should be selected such that the film does not become unacceptably non-uniform and can meet the quality requirements for optical films following the first and second process steps.

The term orient as used herein refers to a process step in which the film dimensions are changed and molecular orientation is induced in one or more of the polymeric materials making up the film. In a second process step, referred to generally herein as the second draw step, the film is drawn in the downweb (MD) direction under a second set of processing conditions to induce sufficient birefringence in the optical film for a desired application. Further, additional stretch or draw step(s) can be employed separately or in conjunction with the first and second draw steps to improve the optical properties of the film (e.g. optical uniformity, warp, peel adhesion, birefringence and the like). During the second draw step, the film is drawn along a downweb (MD) direction, while being allowed to relax along the crossweb (TD) direction. In some exemplary embodiments, during the second draw step, the film is drawn along a downweb (MD) direction, while being allowed to relax along the crossweb (TD) direction as well as along the normal (thickness) direction (ND).

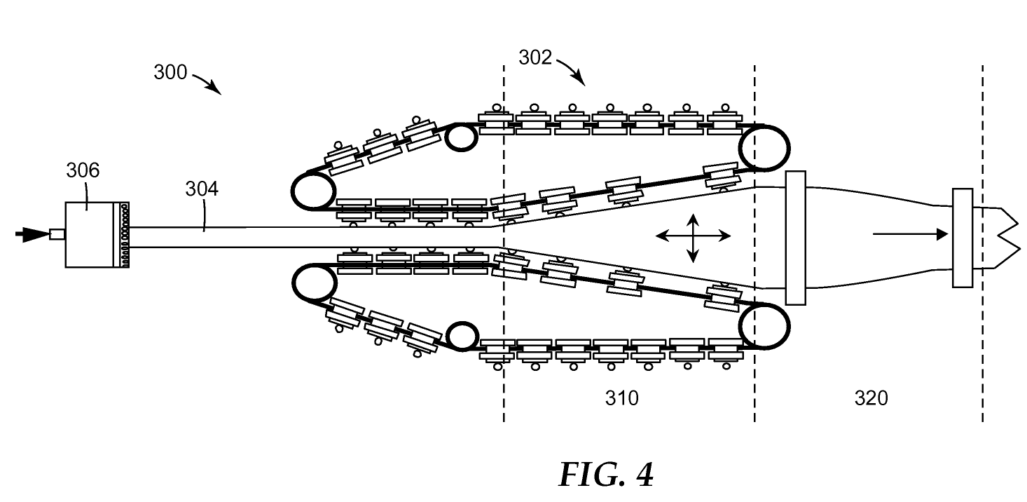

An exemplary process for making the oriented optical films according to the present disclosure is schematically outlined in FIG. 4. First, an optical film is provided to an apparatus 300 that allows the film to be stretched in the crossweb (TD) or downweb (MD) direction, or both, as desired. The stretching steps applied to the film may be sequential or simultaneous. For example, the apparatus in FIG. 4 may include an arrangement of chain or magnetically driven clips 302 that grip the edges of the film web. The individual clips may be computer controlled to provide a wide variety of stretching profiles for the film web 304 as it moves through the apparatus 300.

In an alternative embodiment not shown in FIG. 4, the optical film 304 may be stretched in a profile dictated by an arrangement of varying-pitched screws. The screws control the profile and relative amount of MD stretch and lie along rails that control the TD profile and stretch in combination with other process conditions. In yet another embodiment not shown in FIG. 4, the optical film 304 may be stretched in a profile dictated by a mechanical pantograph-rail system, where the individual clip separation, which in part controls the MD stretch ratio, is controlled by a mechanical pantograph where the TD stretch ratio is in part dictated by the rail path the clips travel. Some exemplary methods and apparatuses suitable for stretching the films according to the present disclosure are described in Kampf U.S. Pat. No. 3,150,433 and Hommes U.S. Pat. No. 4,853,602, both incorporated by reference herein. The film 304 provided into the apparatus 300 may be a solvent cast or an extrusion cast film. In the embodiment illustrated in FIG. 4, the film 304 is an extruded film expelled from a die 306 and including at least one, and preferably two polymeric materials. The optical film 304 may vary widely depending on the intended application, and may have a monolithic structure as shown in FIG. 1, a layered structure as shown in FIG. 2, or a blend structure as shown in FIG. 3, or a combination thereof.

The material selected for use in the optical film 304 should preferably be free from any undesirable orientation prior to the subsequent draw processes. Alternatively, deliberate orientation can be induced during the casting or extrusion step as a process aid to the first draw step. For example, the casting or extrusion step may be considered part of the first draw step. The materials in the film 304 are selected based on the end use application of the optical film, which, following all draw steps, will develop in-plane birefringence and may have reflective properties such as reflective polarizing properties. In one exemplary embodiment described in detail in this application, the optically interfaced materials in the film 304 are selected to provide a film, following all orientation steps, with the properties of a reflective polarizer.

Referring further to FIG. 4, once the optical film 304 is extruded from the die 306 or otherwise provided to the apparatus 300, the optical film 304 is stretched in a first draw step in the zone 310 by an appropriate arrangement of the clips 302 gripping the edges of the film 304. The first draw step is performed under a first set of processing conditions (at least one of draw temperature, draw rate, and draw ratio (e.g. ratio of TD/MD draw rates)) such that the film 304 becomes wider in the crossweb (TD) direction. The first set of processing conditions should be selected such that any additional birefringence induced in the film is low—no more than slight birefringence, preferably substantially no birefringence, and most preferably no birefringence, should be induced in the polymeric materials in the film 304 in the first draw step. In some exemplary embodiments, following the first draw step, the in-plane birefringence is less than about 0.05, less than about 0.03, more preferably less than about 0.02, and most preferably less than about 0.01.

The tendency of a polymeric material to orient under a given set of processing conditions is a result of the visco-elastic behavior of polymers, which is generally the result of the rate of molecular relaxation in the polymeric material. The rate of molecular relaxation can be characterized by an average longest overall relaxation time (i.e., overall molecular rearrangement) or a distribution of such times. The average longest relaxation time typically increases with decreasing temperature and approaches a very large value near the glass transition temperature. The average longest relaxation time can also be increased by crystallization and/or crosslinking in the polymeric material which, for practical purposes, inhibits any relaxation of this longest mode under process times and temperatures typically used. Molecular weight and distribution as well as chemical composition and structure (e.g., branching) can also effect the longest relaxation time.

When the average longest relaxation time of a particular polymeric material is about equal to or longer than the process draw time, substantial molecular orientation will occur in the material in the direction of the draw. Thus, high and low strain rates correspond to processes which draw the material over a period of time which is less than or greater than the average longest relaxation time, respectively. The response of a given material can be altered by controlling the draw temperature, draw rate and draw ratio of the process.

The extent of orientation during a draw process can be precisely controlled over a broad range. In certain draw processes, it is possible that the draw process actually reduces the amount of molecular orientation in at least one direction of the film. In the direction of the draw, the molecular orientation induced by the draw process ranges from substantially no orientation, to slight optical orientation (e.g., an orientation which produces negligible effects on the optical performance of the film), to varying degrees of optical orientation that can be removed during subsequent process steps.

The relative strength of optical orientation depends on the material and the relative refractive indices of the film. For example, strong optical orientation may be in relation to the total intrinsic (normalized) birefringence of the given materials. Alternatively, the draw strength may be in relation to the total amount of achievable normalized index difference between the materials for a given draw process sequence. It should also be appreciated that a specified amount of molecular orientation in one context may be considered strong optical orientation and in another context it may be considered weak or non-optical orientation. For example, a certain amount of birefringence between a first in-plane axis and an out-of-plane axis may be considered low when viewed in the context of a very large birefringence between a second in-plane axis and an out-of-plane axis. Processes which occur in a short enough time and/or at a low enough temperature to induce some or substantial optical molecular orientation of at least one material included in the optical film of the present disclosure are weak or strong optically orienting draw processes, respectively. Processes that occur over a long enough period and/or at high enough temperatures such that little or no molecular orientation occurs are weak or substantially non-optically orienting processes, respectively.

By selecting the materials and process conditions in consideration of the orienting/non-orienting response of the one or more materials to the process conditions, the amount of orientation, if any, along the axis of each draw step may be separately controlled for each material. However, the amount of molecular orientation induced by a particular draw process does not by itself necessarily dictate the resulting film's molecular orientation. A non-optically effective amount of orientation in the first draw process may be permitted for one material in order to compensate for or assist with further molecular orientation in a second or subsequent draw process.

Although the draw processes define the orientational changes in the materials to a first approximation, secondary processes such as densification or phase transitions such as crystallization can also influence the orientational characteristics. In the case of extreme material interaction (e.g. self-assembly, or liquid crystalline transitions), these effects may be over-riding. In typical cases, for example, a drawn polymer in which the main chain backbone of the polymer molecule tends to align with the flow, effects such as strain-induced crystallization tend to have only a secondary effect on the character of the orientation. Strain-induced and other crystallization, does, however, have a significant effect on the strength of such orientation (e.g., may turn a weakly orienting draw into a strongly orienting draw). Therefore, neither of the materials selected for the use in the optical film 304 should be capable of rapid crystallization, and one of the materials should not be capable of appreciable crystallization, under the first set of processing conditions applied in the first draw step. As a result, in some applications, a coPEN that crystallizes more slowly than PEN under the first set of processing conditions, such as a copolymer of PEN and PET, may be preferred. A suitable example is a copolymer of 90% PEN and 10% PET, referred to herein as low melting point PEN (LmPEN).

The first set of processing conditions in the first draw step may vary widely depending on the polymer or polymers making up the film 304. In general, at high temperatures, low draw ratios and/or low strain rates, polymers tend to flow when drawn like a viscous liquid with little or no molecular orientation. At low temperatures and/or high strain rates, polymers tend to draw elastically like solids with concomitant molecular orientation. A low temperature process is typically below, preferably near, the glass transition temperature of amorphous polymeric materials while a high temperature process is usually above, preferably substantially above, the glass transition temperature. Therefore, the first draw step typically should be performed at high temperatures (above the glass transition temperature) and/or low strain rates to provide little or no molecular orientation. In typical embodiments of the present disclosure, in the first draw step, the temperature should be high enough that the polymers do not appreciably orient, but not so high as to cause one or more polymers of the optical film to quiescently crystallize. Quiescent crystallization is sometimes considered undesirable, because it may cause deleterious optical properties, such as excessive haze. In addition, the time over which the film is heated, i.e., the temperature ramp-up rate, should be adjusted to avoid undesirable orientation.

For example, in an optical film such as shown in FIG. 2, with PEN as a high refractive index material, the temperature range for the first draw step is about 20° C. to about 100° C. above the glass transition temperature of at least one of the polymers of the optical film and sometimes all of the polymers of the optical film. In some exemplary embodiments, the temperature range for the first draw step is about 20° C. to about 40° C. above the glass transition temperature of at least one of the polymers of the optical film and sometimes all of the polymers of the optical film.

In the first draw step where the first processing conditions are applied, for example in zone 310 shown in FIG. 4, the film 304 is preferably stretched or drawn in the crossweb (TD) direction. However, the film 304 may optionally also be stretched or drawn in the downweb (MD) direction at the same time the stretch/draw in the crossweb (TD) direction occurs, i.e. the film may be biaxially stretched or drawn, or the film 304 may be stretched in the MD direction subsequent to the stretch in the TD, so long as only low in-plane birefringence, e.g., slight in-plane birefringence, preferably substantially no in-plane birefringence, and more preferably no in-plane birefringence is introduced in the polymeric materials of the film 304.

Following the application to the film 304 of the first set of processing conditions, in another, often subsequent, second draw step a second set of processing conditions is applied to the film in zone 320 shown in FIG. 4. Although a few exemplary specific configurations of the zone 320 are provided below, zone 320 may have any other suitable configuration in which the optical film 304 is drawn in accordance with the principles of the present disclosure. In the second draw step, the optical film 304 is drawn in the downweb (MD) direction such that birefringence is induced in at least one polymeric material in the film and such that after the second draw step, the effective orientation axis of the at least one birefringent material is disposed along the MD. In the embodiment where the optical film includes a first and a second polymeric material, refractive index mismatch is preferably induced between a first material and a second material along a first in-plane axis (e.g., MD) and substantially no refractive index mismatch is induced between the first and the second materials along a second in-plane axis that is orthogonal to the first in-plane axis (e.g., TD). In some exemplary embodiments, the first in-plane axis coincides with the effective orientation axis.

In some exemplary embodiments, normalized in-plane refractive index difference introduced in the second draw step along the stretch direction (MD) is at least about 0.06, at least about 0.07, preferably at least about 0.09, more preferably at least about 0.11, and even more preferably at least about 0.2. In the exemplary embodiments that include at least a first and a second different polymeric materials, following the second draw step the in-plane indices of refraction of the first and second materials along the MD may differ by at least about 0.05, preferably at least about 0.1, more preferably at least about 0.15, and most preferably at least about 0.2. More generally, in case of a reflective polarizer, it is desirable to have the value of refractive index mismatch along the MD as large as possible without significantly degrading other aspects of the optical film. These properties can be improved by additional steps/processes occurring simultaneously with or after the second draw step, described below.

It is also generally desirable that following the second draw step, the normalized refractive index difference, if any, between the matched in-plane refractive indices, e.g., in the in-plane (TD) direction, be less than about 0.06, more preferably less than about 0.03, and most preferably less than about 0.01. Similarly, it can be desirable that any normalized difference between the refractive indices in the thickness direction of an exemplary optical film, e.g., in the out-of-plane (ND) direction, be less than about 0.11, less than about 0.09, less than about 0.06, more preferably less than about 0.03, and most preferably less than about 0.01. Furthermore, in the exemplary embodiments that include at least a first and a second different polymeric materials, following the second draw step the in-plane indices of refraction of the first and second materials along the TD, the ND or the TD and ND may differ by less than about 0.03, more preferably, less than about 0.02, and most preferably, less than about 0.01. In other exemplary embodiments these conditions may be met following the first and second draw steps or following any additional process steps.

In the second draw step, the exemplary optical film 304 is drawn along a first in-plane axis of the film (x or machine direction (MD)) while allowing contraction or relaxation of the film in the second in-plane axis (y or crossweb direction (TD)) as well as along the thickness direction (z or normal direction (ND)) of the film. These processing conditions allow the refractive indices of the birefringent material to acquire a more uniaxial nature, and, therefore, such processes may be referred to as substantially uniaxial stretching or orientation. Thereby, methods of the present disclosure allow production of an oriented optical film comprising a birefringent material characterized by an effective orientation axis along the MD and a normalized difference between a refractive index for light polarized along TD and a refractive index for light polarized along ND being less than 0.06.

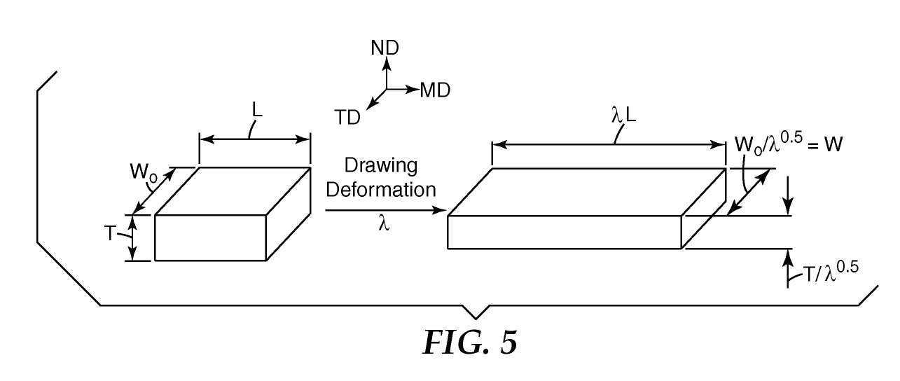

In general, the substantially uniaxial orientation process includes stretching a film that can be described with reference to three mutually orthogonal axes corresponding to the machine direction (MD), the transverse direction (TD), and the normal direction (ND). These axes correspond to the width, length, and thickness of the film, as illustrated in FIG. 5. The substantially uniaxial stretching process stretches a region 32 of the film from an initial configuration 34 to a final configuration 36. The machine direction (MD) is the general direction along which the film travels through a stretching device, the transverse direction (TD) is the second axis within the plane of the film and is orthogonal to the machine direction. The normal direction (ND) is orthogonal to both MD and TD and corresponds generally to the thickness dimension of the polymer film.

Uniaxial orientation of a birefringent polymer provides an optical film (or layers of a film) in which the index of refraction in two of three orthogonal directions is substantially the same (for example, the width (W) and thickness (T) direction of a film, as illustrated in FIG. 5). The index of refraction in the third direction (for example, along the length (L) direction of the film) is different from the indices of refraction in the other two directions. The stretching transformation can be described as a set of draw ratios: the machine direction draw ratio (MDDR), the transverse direction draw ratio (TDDR), and the normal direction draw ratio (NDDR). When determined with respect to the film 32, the particular draw ratio is generally defined as the ratio of the current size (for example, length, width, or thickness) of the film 32′ in a desired direction (for example, TD, MD, or ND) and the initial size (for example, length, width, or thickness) of the film 32 in that same direction.

Perfect uniaxial stretching conditions, with an increase in dimension in the transverse direction, result in MDDR, TDDR, and NDDR of λ, (λ)^{-1/2}, and (λ)^{-1/2}, respectively, as illustrated in FIG. 5 (assuming constant density of the material). In other words, assuming uniform density during the stretch, a film uniaxially oriented along the MD is one in which TDDR=(MDDR)^{-1/2} throughout the stretch. A useful measure of the extent of uniaxial character, U, can be defined as:

$$U = \frac{\frac{1}{TDDR} - 1}{{MDDR}^{1 / 2} - 1}$$

For a perfect uniaxial stretch, U is one throughout the stretch. When U is less than one, the stretching condition is considered “subuniaxial”. When U is greater than one, the stretching condition is considered “super-uniaxial”. States of U greater than unity represent various levels of over-relaxing. If, however, the density of the film changes by a factor of ρ_{f}, where ρ_{f}=ρ₀/ρ with ρ being the density at the present point in the stretching process and ρ₀ being the initial density at the start of the stretch, then NDDR=ρ_{f}/(TDDR*MDDR) as expected. As expected, U can be corrected for changes in density to give U_{f} according to the following formula:

$${U}_{f} = \frac{\frac{1}{TDDR} - 1}{{( \frac{MDDR}{{ρ}_{f}} )}^{1 / 2} - 1}$$

Typically, perfect uniaxial orientation is not required and some degree of deviation from the optimal conditions can be allowed depending on a variety of factors including the end-use application of the optical film. Instead, a minimum or threshold U value or an average U value that is maintained throughout the draw or during a particular portion of the draw can be defined. For example, an acceptable minimum/threshold or average U value can be 0.7, 0.75, 0.8, 0.85, 0.9, or 0.95, as desired, or as needed for a particular application.

As an example of acceptable nearly uniaxial applications, the off-angle characteristics of reflective polarizers used in liquid crystalline display applications is strongly impacted by the difference in the MD and ND indices of refraction when TD is the principal mono-axial draw direction. An index difference in MD and ND of 0.08 is acceptable in some applications. A difference of 0.04 is acceptable in others. In more stringent applications, a difference of 0.02or less is preferred. For example, the extent of uniaxial character of 0.85 is sufficient in many cases to provide an index of refraction difference between the MD and ND directions in polyester systems containing polyethylene naphthalate (PEN) or copolymers of PEN of 0.02or less at 633 nm for mono-axially transverse drawn films. For some polyester systems, such as polyethylene terephthalate (PET), a lower U value of 0.80 or even 0.75 may be acceptable because of lower intrinsic differences in refractive indices in non-substantially uniaxially drawn films.

For sub-uniaxial draws, the final extent of truly uniaxial character can be used to estimate the level of refractive index matching between the y (TD) and z (ND) directions by the equation

Δn_{yz}=Δn_{yz}(U=0)×(1−U)

where Δn_{yz} is the difference between the refractive index in the TD direction (i.e., y-direction) and the ND direction (i.e., z-direction) for a value U and Δn_{yz}(U=0) is that refractive index difference in a film drawn identically except that TDDR is held at unity throughout the draw. This relationship has been found to be reasonably predictive for polyester systems (including PEN, PET, and copolymers of PEN or PET) used in a variety of optical films. In these polyester systems, Δn_{yz}(U=0) is typically about one-half or more the difference Δn_{xy}(U=0) which is the refractive difference between the two in-plane directions TD (y-axis) and MD (x-axis). Typical values for Δn_{xy}(U=0) range up to about 0.26 at 633 nm. Typical values for Δn_{yz}(U=0) range up to 0.15 at 633 nm. For example, a 90/10 coPEN, i.e. a copolyester comprising about 90% PEN-like repeat units and 10% PET-like repeat units, has a typical value at high extension of about 0.14 at 633 nm. Films comprising this 90/10 coPEN with values of U of 0.75, 0.88 and 0.97 as measured by actual film draw ratios with corresponding values of Δn_{yz} of 0.02, 0.01 and 0.003 at 633 nm have been made according to the methods of the present invention.

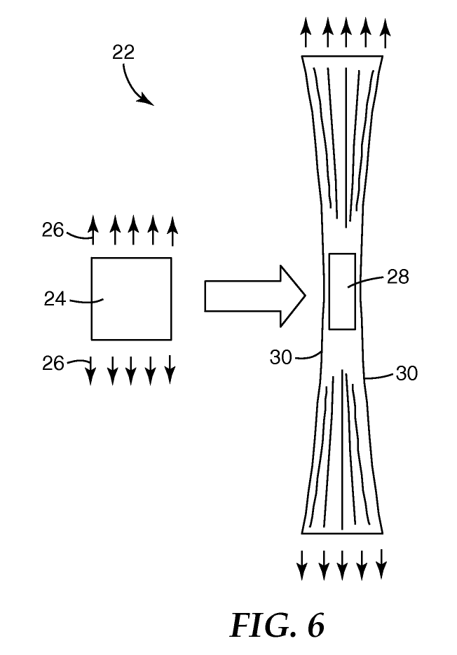

Various methods can be used to orient the film in the second draw step in the zone 320. For example, FIG. 6 illustrates a batch technique for substantially uniaxially stretching an optical film such as, for example, a multilayer optical film, suitable for use as a component in an optical body such as a polarizer. The flat, initial film 24 is stretched in the direction of the arrows 26 to produce a stretched film 22. The film 22 necks down so that two edges 30 of the film are no longer parallel after the stretching process. The central portion of the film 28 provides the most useful optical properties.

In other exemplary embodiments, a length orienter (LO) may also be used to make substantially uniaxially oriented polarizing film. The LO draws the film longitudinally in the machine direction (MD) across at least one span between rollers of differing speed, so that the machine direction draw rate (MDDR) imparted along this span or draw gap is essentially the ratio of the speed of the downstream roll to the upstream roll. Because the film freely spans the rollers without edge constraints, the film can neck down in width along the transverse direction as well as thin in caliper along a direction normal to the plane of the film (ND or z direction) as it draws.

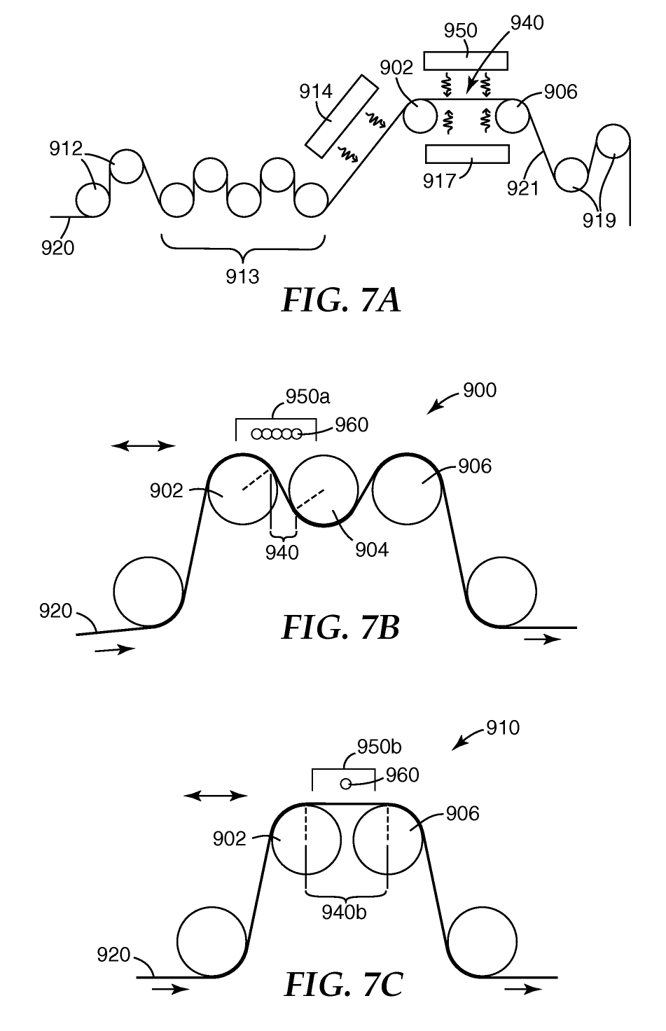

FIG. 7A illustrates a portion of a suitable embodiment of a film line including an LO. The continuous film 920 may be conveyed by rollers 912 into a preheat zone. The preheat zone may comprise a bank of heated rollers 913, a radiant heating source 914, a pre-heat oven, or any combination of these. Following pre-heating, the film 920 is conveyed to one or more stretching zones, each comprising an initial slow roll 902 and a final fast roll 906. Each is typically driven so that the slow roll 902 resists the pull of the film from the action of the fast roll 906 through the draw gap 940. In an exemplary embodiment, the film 920 is further heated in the draw gap 940. One typical heating method is radiant heating, such as by IR heating assemblies 950 and/or 917.

In an exemplary embodiment, after draw across the gap 940, the film 920 is quenched. Typically, the fast roll 906 is a chilled roll set to at least begin the quenching of the film 920. In practice, it may be found that film 920 is not quenched immediately upon contact with fast roll 906 but is instead further drawn for a short distance over fast roll 906. In one embodiment, the further drawing occurs over about an inch of film 920 after contact with fast roll 906. Further cooling may continue, such as through the quenching action of additional rolls 919. These rolls 919 may be set at a reduced speed relative to the fast roll 906, for example to decrease the film tension and allow MD shrinkage or to account for thermal contraction upon cooling. In some cases, a final finishing zone 921 can be used. In one embodiment, finishing zone 921 is also heated, such as with radiant heaters, to allow MD shrinkage while separating this process from the tension in a stretching draw gap.

FIGS. 7B and 7C are schematic diagrams of two embodiments of a length orienter threading system 900 and 910. FIG. 7B, pull rolls 902, 904, and 906 are set up in an S-wrap configuration. In FIG. 7C, the pull rolls are set up in a straight, normal, or tabletop configuration. In exemplary embodiments, in relative terms, roll 902 rotates slowly, roll 904 rotates at an intermediate rate of speed, and roll 906 rotates quickly. In exemplary embodiments, in relative terms, roll 902 is heated and roll 906 is cooled.

The term length orienter encompasses the range of stretching apparatuses in which a continuous film or web of polymer 920 is conveyed and stretched in the span or draw gap 940 between at least one pair of rollers, in which the linear (tangential) velocity of the downstream roll 906 is higher than the linear velocity of the upstream roll 902 of the pair. The ratio of the differential velocities along the film path, fast to slow roll, is approximately equal to the machine-direction draw ratio (MDDR) across the span 940.

Film 920 is conveyed through a series of pre-heated rollers 902, 904, 906 to a draw gap 940, 940b. The film 920 is drawn due to the differences in speed between the initial and final rollers defining the draw gap 940, 940b. Typically, the film 920 is heated, for example, with infrared radiation, as it spans the gap 940, 940b to soften the film 920 and facilitate the drawing above the glass transition temperature. The embodiments depicted in FIGS. 7B and 7C employ heating assemblies 950a-b, including heat elements 960, for providing a distribution of heat to the longitudinal stretch zone 940 or 940b of the film 920.

In some exemplary embodiments of the present disclosure, uniaxial films 920 can be made using the length orienter 900 using large heated draw gap (L) 940 to film width (W) aspect ratios (L/W) and low MD draw ratios (λ_{MD}). For a given total L and a given λ_{MD}, the uniaxial character, and thus also the total crossweb (TD) uniformity, can sometimes be enhanced by dividing the draw gap 940 into two or more separate segments for a given desired λ_{MD} and/or W. In the exemplary embodiments utilizing a multiple draw gap configuration, following pre-heating, the film 920 is conveyed to one, two or more stretching zones, each comprising an initial slow roll 902 and a final fast roll 906. Each draw gap is typically driven so that the slow roll 902 resists the pull of the film from the action of the fast roll 906 through the draw gap 940 or 940b.

In the illustrated embodiment, following a first draw gap having a first fast roll and a first slow roll, a second draw gap, such as a draw gap 940 or 940b can be configured in series. Like the first draw gap, each subsequent, e.g., second, draw gap may comprise a second slow roll and a second fast roll. In some exemplary embodiments, the first fast roll may be the same roll as the second slow roll. In some configurations, isolating rollers will intervene between the first and second draw gaps.

Various other aspects of substantially uniaxial orientation of optical films are described for example in commonly owned U.S. Pat. Nos. 6,939,499; 6,916,440; 6,949,212; and 6,936,209; and 3M Docket No. 61869US002, entitled “Processes For Improved Uniformity Using A Length Orienter,” and 61868US002, entitled “Multiple Draw Gap Length Orientation Process For Improved Uniaxial Character and Uniformity”, filed on even date herewith and incorporated herein by reference to the extent they are consistent with the present disclosure.

While the exact details of the second set of processing conditions may vary widely depending on the materials selected for use in the optical film 304, the second set of processing conditions typically includes a lower temperature than the first set of processing conditions, and may also include a higher draw rate and/or draw ratio. For example, in a layered optical film such as shown in FIG. 1, with PEN as a high index material and coPEN as a low index material, the temperature range used in the second draw step should be about 10° C. below the glass transition temperature to about 60° C. above the glass transition temperature of the polymeric materials in the optical film. To produce a reflective polarizer, for example, following the second draw step it is generally desirable that the difference if any, in the matched refractive indices, e.g., in the in-plane (TD) direction, be less than about 0.05, more preferably less than about 0.02, and most preferably less than about 0.01. In the mismatched direction e.g., in-plane (MD) direction, it is generally desirable that the difference in refractive indices be at least about 0.06, more preferably greater than about 0.09, and even more preferably greater than about 0.11. More generally, it is desirable to have this difference as large as possible without significantly degrading other aspects of the optical film.

In some exemplary embodiments, following the completion of the second draw step in the apparatus 300, the film 304 may be processed through additional steps as desired for a particular application. The second or additional steps may be draw steps performed on a LO along the same process line, or the film may be removed from the process line 300 and moved to a different process line and introduced into the LO or another processing apparatus using a roll-to-roll process. If desired, the birefringence of the film may be altered in the second or additional steps. Following the second and/or additional draw steps, the film or any layer or film disposed thereon may optionally be treated by applying any or all of corona treatments, primer coatings or drying steps in any order to enhance its surface properties, e.g., for subsequent lamination steps.

Prior to or after the second draw step, the film or any layer or film disposed thereon may optionally be treated by applying any or all of corona treatments, primer coatings or drying steps in any order to enhance its surface properties for subsequent lamination steps.

While a particular order is exemplified for the various draw processes described in the above embodiments, the order is used to facilitate an explanation and is not intended to be limiting. In certain instances the order of the processes can be changed or performed concurrently as long as subsequently performed processes do not adversely affect previously performed processes. For example, as noted above, the optical film may be drawn in both directions at the same time. When the film is concurrently drawn along both in-plane axes the draw temperature will be the same for the materials in the film. The draw ratio and rate, however, may be separately controlled. For example, the film may be drawn relatively quickly in the MD and relatively slowly in the TD.

The materials, draw ratio and rate of the concurrent biaxial draw may be suitably selected such that a draw along a first draw axis (e.g., the quick draw) is optically orienting for one or both materials along the first draw axis while the draw in the other direction (e.g., the slow draw) is non-orienting (or non-optically orienting for one of the two materials along the second draw axis. Thus, the response of the two materials to the draw in each direction may be independently controlled.

The exemplary methods of the present disclosure may further include a heat setting or annealing step, preferably performed after the second draw step. Heat setting processes suitable for use with exemplary embodiments of the present disclosure are described, for example in the commonly owned U.S. application Ser. No. 11/397,992, filed on Apr. 5, 2006, entitled “Heat Setting Optical Films,” the disclosure of which is hereby incorporated by reference herein.

As explained in the above referenced application, in contrast to the heat set behavior of conventional one-direction stretched materials, which have significant differences in ny and nz immediately following stretching, the heat setting of substantially uniaxially stretched films, in which contraction is allowed in the y and z directions to minimize differences in ny and nz, has a completely different effect. Heat setting following a substantially uniaxial stretching process maintains or decreases any small existing refractive index asymmetry of these films. Thus, where the refractive indices in the y & z directions become more equal, fewer problems with undesirable color effects arise.

The heat setting procedures described below may be applied following any process that provides substantially uniaxial stretching of an optical film such as, for example, a multilayer optical film (MOF). The heat setting procedures described in this disclosure are particularly useful for substantially uniaxially stretched films including one or more polyester layers.

For the purposes of this disclosure, the term heat set refers to a heating protocol in which an exemplary film of the present disclosure, e.g., 101, 111, 201 or 400, is heated following orientation to enhance film properties such as, for example, crystal growth, dimensional stability, and/or overall optical performance. The heat setting is a function of both temperature and time, and factors must be considered such as, for example, commercially useful line speed and heat transfer properties of the film, as well as the optical clarity of the final product. In an exemplary embodiment, the heat setting process involves heating the film to above the glass transition temperature (Tg) of at least one polymeric component thereof, and preferably above the Tg of all polymeric components thereof Exemplary polymeric materials include PEN, PET, coPENS, polypropylene and syndiotactic polystyrene. In one embodiment of the heat setting process, the film is heated above the stretch temperature of the film, although this is not required. In another embodiment, in the heat setting process the film is heated to a temperature between the Tg and the melting point of the film.

In general, there is an optimal temperature for the rate of crystallization that results from a balance of the kinetic and thermodynamics of the system. This temperature is useful when minimization of the heat set time is a primary consideration. A typical starting point for tuning the conditions to find the best balance between the various product and process considerations is about halfway between the Tg and the melting point of the film. For example, the glass transition temperatures for PET and PEN are approximately 80° C. and 120° C., respectively, under dry conditions. The glass transition temperatures of copolymers of intermediate compositions of PET and PEN (so-called “coPENs” ) are intermediate between those of the homopolymers. The melting points cover a range of temperatures due to the range of imperfections in the physical crystals due to their size and constraints. A rough estimate for the melting points of PET and PEN is about 260° C. for PET and about 270° C. for PEN. The melting points of the so-called coPENs are typically less than those of the homopolymers and can be measured approximately, for example by Differential Scanning Calorimetry (DSC).

Thus, the starting point range for heat setting in PET and PEN is, for example, between about 170 and 195° C. Actual process setpoints depend on residence times and heat transfer within a given process. Residence times may range from about 1 second to about 10 minutes and depend not only on process conditions but also the desired final effect, for example, the amount of crystallinity, the increase in delamination resistance, and optimization of haze given other properties. Minimizing the residence time is often useful for considerations such as minimizing equipment size. Higher temperatures may reduce the required time to attain a certain level of crystallinity. However, higher temperatures also may cause melting of imperfect crystalline structures that may then re-form into larger structures. This may produce unwanted haze for some applications.

Heat setting of the optical films according to the present disclosure may be followed by quenching. The film is quenched when all components reach a temperature level below their glass transition temperatures. In some other embodiments, quenching is performed outside the stretching apparatus.

In some exemplary embodiments, direct converting of the films according to the present disclosure to a finished product takes place after the film is removed from the stretching apparatus, such as 300, and had been stored in roll form. In one example, the film may be unwound and transferred to an optional additional heating unit. In the additional heating unit, the film may be gripped and placed under tension as needed to prevent wrinkling. This process typically takes place at a temperature below the original stretch temperature applied during the second draw step. The additional heating unit may simply be an oven where the film may be placed in roll or sheet form to enhance its properties. The film may be heated to a temperature below the Tg of at least one film component, preferably below the Tg of all film components. The second heat setting or soaking step may continue for an extended period such as, for example, hours or days, until the desired film properties such as shrinkage resistance, or creep resistance are achieved. For example, heat soak for PET is typically performed at about 50-75° C. for several hours to days, while heat soak for PEN is typically performed at about 60-115° C. for several hours to days. Heat soaking can also be achieved in part under some post-processing activities. For example, the film may be coated and dried or cured in an oven with some heat soaking effect.

Following the additional heat setting step, the film may optionally be transferred to an additional quench and/or set zone. In the second quench and/or set zone, the film may be placed under tension and/or toed-in along converging rails to control shrinkage and warping. Following the optional second quench and/or set zone, the film may be re-rolled.

The present disclosure is also directed to methods of increasing uniaxial orientation of optical films. An exemplary method includes providing a drawn film having an initial breadth dimension and direction; constraining the drawn film in a direction substantially perpendicular to the breadth direction while not constraining the drawn film in the breadth direction; and heating the drawn film above a glass transition temperature of at least one component thereof to allow for a reduction of the initial breadth.

In one exemplary embodiment, an optical film comprising a polyester or co-polyester with at least some PET-like or PEN-like moieties, such as terephthalate or naphthalate based sub-units along the chain axis, is formed by drawing the film in one in-plane direction while maintaining or reducing the breadth in the perpendicular in-plane direction to make at least one polyester birefringent so that the refractive index for light polarized along the draw direction is below a critical value that allows for breadth reduction in a further heated step.

If the film is drawn along MD, then the breadth is the TD direction and vice versa. In exemplary embodiments, the optical film can comprise a multi-layer film with alternating layers of two different materials, a multi-layer optical film with three or more layers of different materials in at least some type of repeating pattern, a continuous/disperse blend or bi-continuous blend with a continuous polyester phase, or any combination of these. Particularly useful examples of such polyesters include PET, PEN and the coPENs which are random or block co-polymers of intermediate chemical composition between PET and PEN.

The drawing conditions that allow the breadth reduction upon orientation depend on the processing temperature history, strain rate history, draw ratios, molecular weights (or IV of the resin) and the like. Typically, it is desired that the film be drawn sufficiently to initiate strain-induced crystallization but not so much as to cause high levels of crystallinity. For exemplary effective draws near the glass transition temperature, the draw ratio typically is under 4, more typically under 3.5, or even 3.0 or less. Typical temperatures are within 10 degrees C. above the glass transition temperature for typical initial draw rates of 0. s1ec⁻¹ or more. For higher temperatures, higher rates are typically used to maintain the same level of effective drawing. Alternatively, higher draw ratios may be allowed. The level of breadth reduction for a film as a function of orientation in a continuous phase may also be altered by the extent and nature of a dispersed or bi-continuous phase.

Another method for determining the level of draw is to measure the effectiveness of that draw on the resulting refractive indices. Above a critical draw index for a given polyester resin, the breadth reduction becomes slight, for example below 10%. Below this critical draw index, significant breadth reduction can occur in a subsequent step, given sufficient time, heating and relaxation of constraints. In many cases, the relative birefringence can also be reduced with the breadth reduction step. For a coPEN comprising 90% PEN-like moieties and 10% PET-like moieties, the critical draw index at 632.8 nm is between 1.77 and 1.81. A best estimate is about 1.78. The critical draw index for PEN is less than 1.79 and probably similar to the value for the 90/10 coPEN. A rough estimate for PET is between 1.65 and 1.68. As a first approximation, coPEN values can be estimated as roughly increasing from the PET values to the PEN values as the coPEN increasingly becomes more like PEN in chemical composition. However, since the level of crystallinity at a given draw index may impact the ability for structural re-arrangement, it may be expected that coPEN critical index values may be higher than these first approximations, as may be indicated from the comparison between the coPEN 90/10 and pure PEN estimates. In general, critical values can be found by heat setting drawn samples of measured index values mounted to provide a large L/W ratio where L is along the direction of draw, and observing the cross-draw width reduction after heat setting. Finally, it should be noted that the critical values may change with severe changes in temperature, such as by heat setting at temperatures near the melting point.

An L.O. can be particularly useful in achieving such drawing conditions while maintaining a reasonably uniform draw ratio along the stretching direction (MDDR in the case of an L.O.). Cross-drawn films, e.g. as drawn in a tenter or a batch stretching device, may be prone to more draw ratio non-uniformities along the stretching direction (TDDR in these case) and thus more product non-uniformities due to cross-web temperature variations and the like. Thus, a particularly useful process uses an L.O. to provide at least the initial drawing step prior to breadth reduction.

The breadth reduction step is accomplished in a manner so that the film can pull-in across its breadth perpendicular to the direction of the first drawing step. When the breadth reduction step is accomplished across a draw gap of an L.O., the L/W ratio is important in controlling the extent and uniformity of the breadth reduction. An L/W ratio of at least 1 is typically desired. Values of 5, 10 or more can be used. It may be useful to use the lowest allowable L/W that achieves the desired breadth reduction to minimize flutter and wrinkling. The temperature and time are preferably of sufficient amount and extent to allow the strain recoil in the process step. Typical conditions for the breadth reduction step comprise heating the film above the glass transition temperature of each continuous phase material in the construction for at least one second. More typically, the heating is to at least the average temperature of the drawing step for at least the time used to accomplish the draw step. In other cases, the temperature of the film is more than 15 degrees C. above the glass transition temperature of each continuous phase material in the construction for 1, 5, 15, 30 seconds or more.

The breadth reduction step may result in a leveling of the thickness due to uneven neck down during the first drawing step. Likewise, a more level distribution of the cross-breadth draw ratio (e.g. TDDR for a film drawn along MD) across the breadth of the film may be achieved as well as a more consistent extent of uniaxial character across the film. In this manner, a more uniform film can be formed. Thus, in one embodiment, the disclosure describes a low draw ratio process with additional heat setting to create breadth reduction and improved uniaxial character regardless of the stretch direction.

The breadth reduction step may also result in an increase in the haze level. Generally, the closer to the critical index, the less the haze increase. In some applications, the level of heat treatment with its reduction in relative birefringence can be balanced against increases in haze as a function of the use of the film so formed for a given optical application.

Following the second or third, or, in some embodiments, any number of suitable additional steps, the oriented optical film may be laminated to or otherwise combined with a wide variety of materials to make various optical constructions, some of which may be useful in display devices, such as LCDs. Oriented optical films of the present disclosure or any suitable laminate constructions including oriented optical films according to the present disclosure can be advantageously provided in roll form.

For example, any of the polarizing films described above may be laminated with or have otherwise disposed thereon a structured surface film such as those available under the trade designation BEF from 3M Company of St. Paul, Minn. In one embodiment, the structured surface film includes an arrangement of substantially parallel linear prismatic structures or grooves. In some exemplary embodiments, the optical film 304 may be laminated to a structured surface film including an arrangement of substantially parallel linear prismatic structures or grooves. The grooves may be aligned along the down web (MD) direction (and along the effective orientation axis or the block axis in case of a reflective polarizer), or the grooves may be aligned along the crossweb (TD) direction (and along the transmission or pass axis of a reflective polarizer film). In other exemplary embodiments, the grooves of an exemplary structured surface film may be oriented at another angle with respect to the effective orientation axis of the oriented optical film according to the present disclosure.

Those of ordinary skill in the art will readily appreciate that the structured surface may include any other types of structures, a rough surface or a matte surface. Such exemplary embodiments may also be produced by inclusion of additional steps of coating a curable material onto the optical film of the present disclosure, imparting surface structures into the layer of curable material and curing the layer of the curable material.

Since exemplary reflective polarizers made according to the processes described herein have a block axis along the downweb (MD) direction, the reflective polarizers may simply be roll-to-roll laminated to any length oriented polarizing film. In other exemplary embodiments, the film may be coextruded with a layer of absorbing polarizer material, such as a dichroic dye material or PVA-containing layer, or coated with such a layer prior to the second draw step.

FIG. 8 illustrates an optical film construction 400 in which a first optical film 401, such as a reflective polarizer with a block axis along a direction 405, is combined with a second optical film 403. The second optical film 403 may be another type of optical or non-optical film such as, for example, an absorbing polarizer, with a block axis along a direction 404.

In the construction shown in FIG. 8, the block axis 405 of the reflective polarizing film 401 should be aligned as accurately as possible with the block axis 404 of the dichroic polarizing film 403 to provide acceptable performance for a particular application as, for example, a brightness enhancement polarizer. The pass or transmission axis of the reflective polarizing film is designated as 406. Increased mis-alignment of the axes 404, 405 diminishes the gain produced by the laminated construction 400, and makes the laminated construction 400 less useful for some display applications. For example, for a brightness enhancement polarizer the angle between the block axes 404, 405 in the construction 400 should be less than about ±10°, more preferably less than about ±5° and more preferably less than about ±3°.

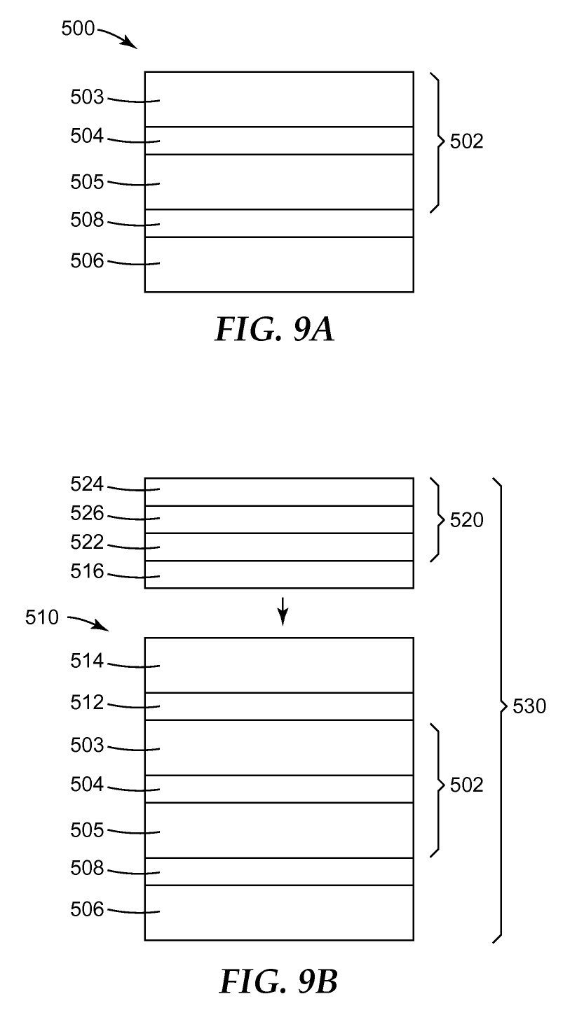

In an embodiment shown in FIG. 9A, a laminate construction 500 includes an absorbing polarizing film 502. In this exemplary embodiment, the absorbing polarizing film includes a first protective layer 503. The protective layer 503 may vary widely depending on the intended application, but typically includes a solvent cast cellulose triacetate (TAC) film. The exemplary construction 500 further includes a second protective layer 505, as well as an absorbing polarizer layer 504, such as an iodine-stained polyvinyl alcohol (I₂/PVA). In other exemplary embodiments, the polarizing film may include only one or no protective layers. The absorbing polarizing film 502 is laminated or otherwise bonded to or disposed on an optical film reflective polarizer 506 (as described herein having an MD block axis), for example, with an adhesive layer 508.

Any suitable absorbing polarizing materials may be used in the absorbing polarizing films of the present disclosure. For example, in addition to iodine-stained polyvinyl alcohol (I₂/PVA)-based polarizers, the present disclosure encompasses polyvinylidene-based light polarizers (referred to as KE-type polarizers, and further described in U.S. Pat. No. 5,973,834, incorporated by reference herein), iodine-based polarizers, dyed PVOH polarizers and other suitable absorbing polarizers.

FIG. 9B shows an exemplary polarizer compensation structure 510 for an optical display, in which the laminate construction 500 is bonded to an optional birefringent film 514 such as, for example, a compensation film or a retarder film, with an adhesive 512, typically a pressure sensitive adhesive (PSA). In the compensation structure 510, either of the protective layers 503, 505 may optionally be replaced with a birefringent film, such as a compensator or a retarder, that is the same or different than the compensation film 514. Such optical films may be used in an optical display 530. In such configurations, the compensation film 514 may be adhered via an adhesive layer 516 to an LCD panel 520 including a first glass layer 522, a second glass layer 524 and a liquid crystal layer 526.

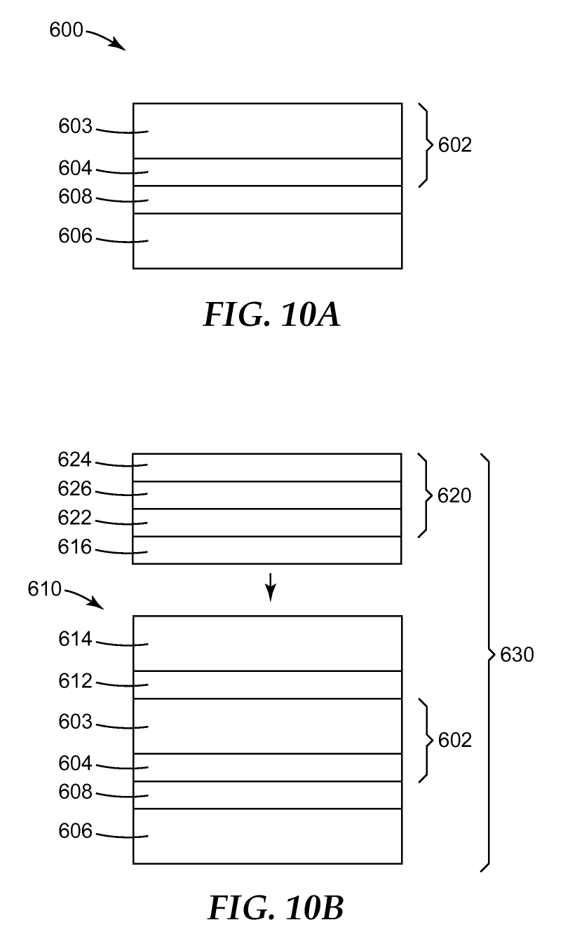

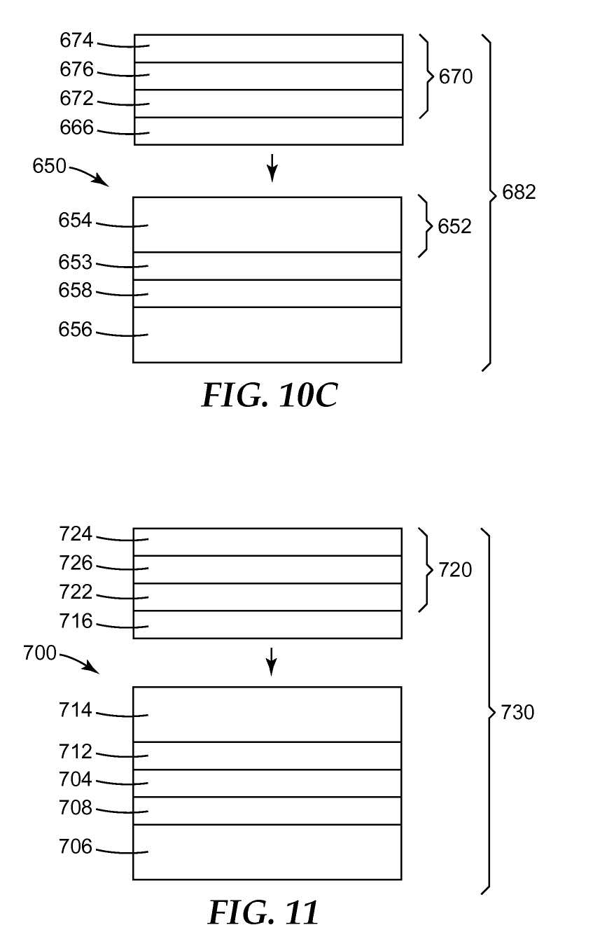

Referring to FIG. 10A, another exemplary laminate construction 600 is shown that includes an absorbing polarizing film 602 having a single protective layer 603 and an absorbing polarizing layer 604, e.g., a I₂/PVA layer. The absorbing polarizing film 602 is bonded to an MD polarization axis optical film reflective polarizer 606, for example, with an adhesive layer 608. In this exemplary embodiment, the block axis of the absorbing polarizer is also along the MD. Elimination of either or both of the protective layers adjacent to the absorbing polarizer layer 604 can provide a number of advantages including, for example, reduced thickness, reduced material costs, and reduced environmental impact (solvent cast TAC layers not required).

FIG. 10B shows a polarizer compensation structure 610 for an optical display, in which the laminate construction 600 is bonded to an optional birefringent film 614 such as, for example, a compensation film or a retarder film, with an adhesive 612. In the compensation structure 610, the protective layer 603 may optionally be replaced with a birefringent film that is the same or different than the compensation film 614. Such optical films may be used in an optical display 630. In such configurations, the birefringent film 614 may be adhered via an adhesive layer 616 to an LCD panel 620 including a first glass layer 622, a second glass layer 624 and a liquid crystal layer 626.

FIG. 10C shows another exemplary polarizer compensation structure 650 for an optical display. The compensation structure 650 includes an absorbing polarizing film 652 with a single protective layer 653 and an absorbing polarizer layer 654, such as I₂/PVA layer. The absorbing polarizing film 652 is bonded to an MD block axis reflective polarizer 656, for example, with an adhesive layer 658. In the compensation structure 650, the protective layer 653 may optionally be replaced with a compensation or retarder film. To form an optical display 682, the absorbing polarizer layer 654 may be adhered via adhesive layer 666 to an LCD panel 670 including a first glass layer 672, a second glass layer 674 and a liquid crystal layer 676.

FIG. 11 shows another exemplary polarizer compensation structure 700 for an optical display, in which the absorbing polarizing film includes a single layer of absorbing polarizer material (e.g., I₂/PVA) layer 704 without any adjacent protective layers. One major surface of the layer 704 is bonded to an MD block axis optical film reflective polarizer 706 such that the block axis of the absorbing polarizer is also along MD. Bonding may be accomplished with an adhesive layer 708. The opposite surface of the layer 704 is bonded to an optional birefringent film 714 such as, for example, a compensation film or a retarder film, with an adhesive 712. Such optical films may be used in an optical display 730. In such exemplary embodiments, the birefringent film 714 may be adhered via adhesive layer 716 to an LCD panel 720 including a first glass layer 722, a second glass layer 724 and a liquid crystal layer 726.

The adhesive layers in FIGS. 8-11 above may vary widely depending on the intended application, but pressure sensitive adhesives and H₂O solutions doped with PVA are expected to be suitable to adhere the I₂/PVA layer directly to the reflective polarizer. Optional surface treatment of either or both of the reflective polarizer film and the absorbing polarizer film using conventional techniques such as, for example, air corona, nitrogen corona, other corona, flame, or a coated primer layer, may also be used alone or in combination with an adhesive to provide or enhance the bond strength between the layers. Such surface treatments may be provided in-line with the first, second draw steps or considered separate steps and may be prior to the first draw step, prior to the second draw step, subsequent to the first and second draw steps or subsequent to any additional draw steps. In other exemplary embodiments, a layer of absorbing polarizer material may be coextruded with an exemplary optical film of the present disclosure.

The following examples include exemplary materials and processing conditions in accordance with different embodiments of the disclosure. The examples are not intended to limit the disclosure but rather are provided to facilitate an understanding of the invention as well as to provide examples of materials particularly suited for use in accordance with the various above-described embodiments. Those of ordinary skill in the art will readily appreciate that exemplary embodiments shown in FIGS. 8-11 may be modified in any way consistent with the spirit of the present disclosure. For example, any suitable number or combination of layers or films described above may be used in exemplary embodiments of the present disclosure.

### EXAMPLES

In the following examples, the samples were heated for stretching for 10 to 60 seconds, as appropriate for the specific materials. Most typical heating times were 30 to 50 seconds. In the first draw step, the films were stretched by 10 to 60% per second, and more typically by 20 to 50% per second. In the second draw step, the films were stretched by 40 to 150% per second, and more typically by 60 to 100% per second. The terms “initial” and “final” are used to refer to the first and second draw steps, respectively.

### Example 1

Monolayer PEN cast films were stretched according to the three sets of processing conditions set forth in Table 1 below.

TABLE 1

| | | | | | Stretch | Stretch | | | | | | |
|---|---|---|---|---|---|---|---|---|---|---|---|---|
| | TD | TD | MD | MD | Temp | Temp | Anneal @ | | | | | |
| Sample | Init. | Fin. | Init. | Fin. | Init. ° C. | Fin. ° C. | 175° C. | n_{md} | n_{td} | n_{zd} | Δn_{MD} − n_{TD} | Δn_{TD} − n_{ZD} |
| A | 4.2 | 2 | 3 | 6.5 | 158 | 152 | No | 1.829 | 1.633 | 1.517 | 0.196 | 0.116 |
| B | 4.2 | 2 | 3 | 6.5 | 158 | 152 | Yes | 1.829 | 1.646 | 1.505 | 0.183 | 0.141 |
| C | 2 | 2 | 3 | 5 | 148 | 148 | No | 1.806 | 1.641 | 1.522 | 0.165 | 0.119 |

The process used to make samples A & B included a relaxation step, and the process used to make sample B also included an annealing step. The process used to make sample C included no relaxation step or anneal step, but a lower MD second draw step. It is believed that any of these exemplary processes could be used to generate a reflective polarizer if sample A-C is used as an optical layer in a multilayer optical film or a component of a diffusely reflective polarizing film.

### Example 2

Monolayer LmPEN (95:5 PEN/PET) cast films were stretched according to the processing conditions set forth in Table 2 below.

TABLE 2

| | | | | | Stretch | Stretch | | | | | | |
|---|---|---|---|---|---|---|---|---|---|---|---|---|
| | | | | | Temp | Temp | | | | | | |
| | TD | TD | MD | MD | Initial | Final | Anneal @ | | | | | |
| Sample | Initial | Final | Initial | Final | ° C. | ° C. | 175° C. | n_{md} | n_{td} | n_{zd} | Δn_{MD} − n_{TD} | Δn_{TD} − n_{ZD} |
| D | 4.2 | 3 | 3 | 7.3 | 150 | 135 | Yes | 1.800 | 1.625 | 1.512 | 0.175 | 0.113 |
| E | 4.2 | 3 | 3 | 7.3 | 153 | 135 | No | 1.786 | 1.629 | 1.521 | 0.157 | 0.108 |
| F | 2 | 2 | 3 | 7.3 | 153 | 135 | No | 1.784 | 1.645 | 1.541 | 0.139 | 0.104 |
| G | 4.2 | 3 | 3 | 7.3 | 150 | 135 | No | 1.783 | 1.629 | 1.527 | 0.154 | 0.103 |
| H | 4.2 | 3 | 3 | 7.3 | 153 | 135 | Yes | 1.809 | 1.628 | 1.525 | 0.181 | 0.103 |
| I | 2 | 2 | 3 | 7.3 | 150 | 135 | No | 1.763 | 1.625 | 1.555 | 0.137 | 0.070 |
| J | 2 | 2 | 3 | 7.3 | 150 | 140 | No | 1.749 | 1.625 | 1.570 | 0.124 | 0.055 |

The process used to make samples D, E, G, & H included a relaxation step. It is believed that any of these processes could be used to generate a reflective polarizer if the above-referenced layer is used as an optical layer in a multilayer optical film or as a component of a diffusely reflective polarizing film. Annealing increased the n_{MD} for samples D and H. The process used to make samples F, I & J did not include a relaxation step. Sample F has a relatively small difference between Δn_{MD}−n_{TD} and Δn_{TD}−n_{ZD}. Samples I and J have lower Δn_{TD}−n_{ZD} and thus would have lower off angle color if they were in a reflective polarizer, compared to the other samples.

### Example 3

Monolayer LmPEN (90:10 PEN/PET) cast films were stretched according to the processing conditions set forth in Table 3 below.

TABLE 3

| | | | | | Stretch | Stretch | | | | | | |
|---|---|---|---|---|---|---|---|---|---|---|---|---|
| | TD | TD | MD | MD | Temp | Temp | Anneal @ | | | | | |
| Sample | Init. | Fin. | Init. | Fin. | Init. ° C. | Fin. ° C. | 175° C. | n_{md} | n_{td} | n_{zd} | Δn_{MD} − n_{TD} | Δn_{TD} − n_{ZD} |
| K | 4.2 | 3 | 3 | 7.3 | 150 | 135 | Yes | 1.803 | 1.633 | 1.518 | 0.170 | 0.115 |
| L | 4.2 | 3 | 3 | 7.3 | 147 | 130 | No | 1.796 | 1.634 | 1.519 | 0.163 | 0.115 |
| M | 2 | 2 | 3 | 7.3 | 150 | 135 | No | 1.728 | 1.631 | 1.561 | 0.096 | 0.071 |
| N | 4.2 | 3 | 3 | 7.3 | 150 | 135 | No | 1.767 | 1.623 | 1.545 | 0.144 | 0.078 |
| R | 4.2 | 3 | 3 | 7.3 | 147 | 130 | No | 1.783 | 1.619 | 1.543 | 0.164 | 0.076 |
| S | 2 | 2 | 2 | 7.3 | 147 | 130 | No | 1.753 | 1.633 | 1.557 | 0.119 | 0.077 |
| T | 3 | 1.9 | 1.9 | 7.3 | 147 | 130 | No | 1.771 | 1.628 | 1.539 | 0.143 | 0.089 |

The process used to make samples K, L, N, R, T included a relaxation step. It is believed that any of these processes could be used to generate a reflective polarizer if the above-referenced layer is used as an optical layer in a multilayer optical film or as a component of a diffusely reflective polarizing film. Annealing increased the n_{MD} for sample K. The process used to make samples M & S included no relaxation step. Sample M had a relatively low difference between Δn_{MD}−n_{TD} and Δn_{TD}−n_{ZD}. Samples N, especially R, and T have lower Δn_{TD}−n_{ZD} and thus would have lower off angle color if they were in a reflective polarizer, compared to the other samples.

### Example 4

Monolayer LmPEN (60:40 PEN/PET) cast films were stretched according to the processing conditions set forth in Table 4 below.

TABLE 4

| | | | | | Stretch | Stretch | | | | | | |
|---|---|---|---|---|---|---|---|---|---|---|---|---|
| | TD | TD | MD | MD | Temp | Temp | Anneal | | | | | |
| Sample | Init. | Fin. | Init. | Fin. | Init. ° C. | Fin. ° C. | @ 175° C. | n_{md} | n_{td} | n_{zd} | Δn_{MD} − n_{TD} | Δn_{TD} − n_{ZD} |
| U | 4.2 | 3 | 3 | 7.3 | 140 | 130 | 160 | 1.705 | 1.604 | 1.566 | 0.101 | 0.038 |
| V | 4.2 | 3 | 3 | 7.3 | 115 | 100 | 125 | 1.723 | 1.616 | 1.551 | 0.106 | 0.065 |
| W | 2 | 2 | 3 | 7.3 | 115 | 110 | No | 1.735 | 1.609 | 1.537 | 0.126 | 0.072 |

The process used to make samples U & V included a relax step, while the process used to make sample W did not. Sample U has a lower Δn_{TD}−n_{ZD} and thus would have lower off angle color were it in a reflective polarizer, compared to other samples. It is believed that any of these processes could be used to generate a reflective polarizer if the above-referenced layer is used as an optical layer in a multilayer optical film or as a component of a diffusely reflective polarizing film.

### Example 5

Monolayer LmPEN (30:70 PEN/PET) cast films were stretched according to the processing conditions set forth in Table 5 below.

TABLE 5

| | | | | | Stretch | Stretch | | | | | | |
|---|---|---|---|---|---|---|---|---|---|---|---|---|
| | TD | TD | MD | MD | Temp | Temp | Anneal @ | | | | | |
| Sample | Init. | Fin. | Init. | Fin. | Init. ° C. | Fin. ° C. | 175° C. | n_{md} | n_{td} | n_{zd} | Δn_{MD} − n_{TD} | Δn_{TD} − n_{ZD} |
| X | 4.2 | 3 | 3 | 7.3 | 115 | 105 | 130 | 1.664 | 1.590 | 1.557 | 0.075 | 0.033 |
| Y | 2 | 2 | 3 | 7.3 | 115 | 105 | 130 | 1.686 | 1.597 | 1.543 | 0.089 | 0.0544 |
| Z | 2 | 2 | 3 | 7.3 | 115 | 105 | 130 | 1.688 | 1.600 | 1.544 | 0.088 | 0.055 |

The process used to make sample X included a relaxation step, while the process used to make samples Y & Z did not. It is believed that any of these processes could be used to generate a reflective polarizer if the above-referenced layer is used as an optical layer in a multilayer optical film or as a component of a diffusely reflective polarizing film.

### Example 6

Multilayer films were prepared having a high index optical (HIO) layer with a 90:10 ratio by weight of PEN:PET (LmPEN) and a low index optical (LIO) layer of a polyester/polycarbonate alloy available from Eastman Chemical, Kingsport, Tenn., under the trade designation Sahara SA 115. The films were stretched under the conditions outlined in Table 6 below.

TABLE 6

| | | | | | | Stretch Temp | Stretch Temp | Anneal temp | |
|---|---|---|---|---|---|---|---|---|---|
| Sample | MOF cast film | TD initial | TD final | MD initial | MD final | Initial ° C. | Final ° C. | (° C.) | Gain |
| RP-A | LmPEN HIO/ | 4.2 | 3 | 3 | 7.3 | 150 | 135 | no | 1.622 |
| | SA115 LIO | | | | | | | | |
| RP-B | LmPEN HIO/ | 4.2 | 3 | 3 | 7.1 | 150 | 135 | no | 1.601 |
| | SA115 LIO | | | | | | | | |
| RP-C | LmPEN HIO/ | 4.2 | 3 | 3 | 7.0 | 150 | 135 | no | 1.585 |
| | SA115 LIO | | | | | | | | |

### Example 7

Multilayer films were prepared having a high index optical (HIO) layer with a 90:10 ratio by weight of PEN:PET (LmPEN) and a low index optical (LIO) layer of a CoPEN with a 55:45 ratio by weight of PEN:PET. The films were simultaneously biaxially stretched under the conditions outlined in Table 7 below.

TABLE 7

| | | | | | | Stretch | Stretch | Anneal | |
|---|---|---|---|---|---|---|---|---|---|
| | MOF Cast | TD | TD | MD | MD | Temp Initial | Tem Final | temp | |
| Sample | Web | Initial | Final | Initial | Final | ° C. | ° C. | (° C.) | Gain |
| RP-1 | LmPen | 4.1 | 3.0 | 3.0 | 7.0 | 158 | 140 | 180 | 1.376 |
| | HIP/Co PEN | | | | | | | | |
| | 55/45 HD LIO | | | | | | | | |
| RP-2 | LmPen | 4.1 | 3.0 | 3.0 | 7.0 | 153 | 140 | 180 | 1.489 |
| | HIP/Co PEN | | | | | | | | |
| | 55/45 HD LIO | | | | | | | | |
| RP-3 | LmPen | 4.1 | 3.0 | 3.0 | 7.3 | 155 | 145 | 180 | 1.559 |
| | HIP/Co PEN | | | | | | | | |
| | 55/45 HD LIO | | | | | | | | |
| RP-4 | LmPen | 3.5 | 3.0 | 3.0 | 7.3 | 155 | 145 | 180 | 1.458 |
| | HIP/Co PEN | | | | | | | | |
| | 55/45 HD LIO | | | | | | | | |
| RP-5 | LmPen | 3.5 | 3.0 | 3.0 | 7.0 | 155 | 145 | 180 | 1.433 |
| | HIP/Co PEN | | | | | | | | |
| | 55/45 HD LIO | | | | | | | | |

### Example 8

PEN films, as well as films with a 90:10 ratio by weight of PEN:PET (LmPEN), were sequentially stretched in a first draw step in the TD followed by a second draw step in the MD, under the conditions outlined in Table 8 below. The film properties resulting from these processing steps are also shown in Table 8.

TABLE 8

| | | | | | | Stretch | | | | | | | |
|---|---|---|---|---|---|---|---|---|---|---|---|---|---|
| | | TD | | MD | | Temp | Stretch | | | | | | |
| | | initial | TD | initial | MD | Initial | Temp | Anneal temp | | | | | |
| Sample | Material | (step 1) | final | (step 1) | final | (step 1) | (step 2) | (° C.) | n_{md} | n_{td} | n_{zd} | Δ n_{MD-TD} | Δ n_{TD-ZD} |
| AA | LmPEN | 4 | 2 | 1 | 6.5 | 150 | 140 | No | 1.684 | 1.603 | 1.586 | 0.081 | 0.017 |
| AB | LmPEN | 4 | 2 | 1 | 6.5 | 150 | 140 | 5 sec @ 170° C. | 1.713 | 1.592 | 1.563 | 0.121 | 0.029 |
| AC | LmPEN | 4 | 2 | 1 | 6.5 | 150 | 140 | 5 sec @ 180° C. | 1.710 | 1.603 | 1.598 | 0.107 | 0.005 |
| AD | LmPEN | 4 | 2 | 1 | 6.5 | 150 | 135 | 10 sec @ 170° C. | 1.734 | 1.591 | 1.562 | 0.143 | 0.029 |
| AE | LmPEN | 5 | 2 | 1 | 6.5 | 150 | 135 | 10 sec @ 170° C. | 1.745 | 1.580 | 1.566 | 0.165 | 0.014 |
| AF | PEN | 4 | 2 | 1 | 6 | 160 | 160 | No | 1.707 | 1.632 | 1.601 | 0.075 | 0.031 |
| AG | PEN | 4 | 2 | 1 | 6 | 160 | 160 | 10 sec @ 170° C. | 1.746 | 1.632 | 1.612 | 0.114 | 0.020 |
| AH | PEN | 4 | 2 | 1 | 6 | 160 | 152 | 10 sec @ 170° C. | 1.811 | 1.618 | 1.551 | 0.193 | 0.067 |

### Example 9

The multilayer films designated RP-A in Example 6 and RP-4 in Example 7 were laminated with additional structured surface layers or films having prismatic grooves with a 90/50 pattern. The structured surface layers or films were laminated at 0 and 90° to the block direction or axis of the multilayer reflective polarizer (MD) and the effective transmission was measured as displayed in Table 9.

TABLE 9

| Sample | Gain | | |
|---|---|---|---|
| construction | Sample only | Grooves \|\| to block | Grooves ⊥ to block |
| RP-A | 1.622 | 1.828 | 1.656 |
| RP-4 | 1.636 | 1.862 | 1.735 |

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method of making an optical film, comprising the steps of:
providing a film comprising at least one polymeric material;
widening the film under a first set of processing conditions in a first draw step along a crossweb (TD) direction such that birefringence, if any, created in the film is low, and
drawing the film in a second draw step along a downweb (MD) direction, while allowing the film to relax along the crossweb (TD) direction, under a second set of processing conditions, wherein the second set of processing conditions creates in-plane birefringence in the polymeric material and an effective orientation axis along the MD.

2. The method of claim 1, wherein the temperature of the film under the first processing conditions is greater than the temperature of the film under the second processing conditions.

3. The method of claim 1, wherein the temperature of the film in the first draw step is from 20-100° C. above the glass transition temperature of the polymer, and wherein the temperature of the film in the second draw step is from 10° C. below the glass transition temperature of the polymer to 40° C. above the glass transition temperature of the polymer.

4. The method of claim 1, wherein the film is more than 0.3 m wide following the second draw step.

5. The method of claim 1, wherein birefringence of the created in the first draw step is less than 0.05 and birefringence created in the second drawing step is at least 0.06.

6. The method of claim 1, further comprising annealing the film following the second draw step.

7. A method of making an optical film, comprising:
providing a film comprising at least a first polymeric material and a second polymeric material,
drawing the film in a first draw step along a crossweb (TD) direction to widen the film under a first set of processing conditions such that low birefringence is created in the first and second polymeric materials along the TD direction, and
drawing the film in a second draw step along a downweb (MD) direction, while allowing the film to relax along the crossweb (TD) direction, under a second set of processing conditions to create in-plane birefringence in at least one of the first and second polymeric materials and an effective orientation axis along the MD.

8. The method of claim 7, wherein the temperature of the film under the first processing conditions is greater than the temperature of the film under the second processing conditions.

9. The method of claim 7, wherein the temperature of the film in the first draw step is from 20-100° C. above the glass transition temperature of the at least one of the first and second polymers, and wherein the temperature of the film in the second draw step is from 10° C. below the glass transition temperature of at least one of the first and second polymers to 40° C. above the glass transition temperature of at least one of the first and second polymers.

10. The method of claim 7, wherein the film is stretched along the MD direction in the first draw step.

11. The method of claim 7, further comprising drawing the film in a third draw step along the downweb (MD) direction under a third set of processing conditions.

12. The method of claim 7, wherein birefringence of the created in the first draw step is less than 0.05 and birefringence created in the second drawing step is at least 0.06.

13. The method of claim 7, wherein the film includes a layer comprising an absorbing polarizer material.

14. The method of claim 7, wherein subsequent the first and second draw steps the film is a reflective polarizer film.

15. The method of claim 7, further comprising annealing the film following the second draw step.

16. A method of making an optical film, comprising:
providing a first film comprising at least a first polymeric material and a second polymeric material,
drawing the first film in a first draw step along a crossweb (TD) direction to widen the first film under a first set of processing conditions such that low in-plane birefringence is created in the first and second polymeric materials along the TD direction,
drawing the first film in a second draw step along a downweb (MD) direction, while allowing the film to relax along the crossweb (TD) direction, under a second set of processing conditions to create in plane birefringence in at least one of the first and second polymeric materials; and
attaching a second film to the first optical film.

17. The method of claim 16, wherein the second film is attached to the first film following the first and second draw steps.

18. The method of claim 16, wherein the second film is selected from the group consisting of structured surface films, retarders, absorbing polarizing films and a combination thereof

19. The method of claim 16, wherein attaching the second film to the first film comprises disposing an adhesive between the first film and the second film.

20. The method of claim 16, wherein the second film is coated on the first film.

21. The method of claim 20, wherein the second film comprises a curable material and attaching the second film further comprises structuring the curable material and curing the curable material to form a structured surface on the first film.

22. The method of claim 16, further comprising applying a surface treatment to the first film prior to attaching a second film to the first optical film.

23. The method of claim 22, wherein the surface treatment is selected from corona treatment, drying, applying a primer, or a combination thereof

24. The method of claim 16, wherein subsequent the first and second draw steps the first film is a reflective polarizer film.

25. The method of claim 16, further comprising annealing the film following the second draw step.
